(19) United States
(12) Patent Application Publication
(10) Pub. No.: US 2002/0190946 A1
(43) Pub. Date: Dec. 19, 2002

(54) Pointing method

(76) Inventor: Ram Metzger, Oranit (IL)

Correspondence Address: William H Dippert, Reed Smith, 375 Park Avenue, New York, NY, 10152-1799, US

(21) Appl. No.: 10/168,634

(22) PCT Filed: Dec. 21, 2000
(86) PCT No.: PCT/IL00/00850

(30) Foreign Application Priority Data
Dec. 23, 1999 (IL) 133698

(51) Int. Cl. G09G 5/00

(52) U.S. Cl. 345/156

(57) ABSTRACT

A method of indicating by a user of a screen location, on a system having a screen (12) displaying content, comprising: entering at least a partial screen address, defining an absolute position on the screen, wherein the screen address can indicate substantially any location on the screen (12); determining a screen location corresponding to the at least a partial address; and pointing, by the system, to the screen location indicated by the at least a partial screen address.

### FIELD OF THE INVENTION

The invention relates in general to a method of pointing on a display.

### BACKGROUND OF THE INVENTION

Many current operating systems require a pointing and clicking device, such as a mouse. These systems, or applications executing under them, typically two cursors, a text cursor and a pointing cursor. The text cursor is controlled by a keyboard and to some extent by the mouse and the pointing cursor is controlled by the mouse. Although working with a mouse is considered by many users easy and operator-friendly, some users find using the mouse uncomfortable.

Furthermore, in switching back and forth between the keyboard and the mouse, a user must continuously change his hand positions between a touch-typing position and a mouse holding (pointing) position. Generally, this slows down the user's work, as the user may be required to move his gaze direction to locate the mouse, move his hand a significant distance and then move the hand back to the keyboard.

An additional problem with mouse-type pointing devices is an apparent increased risk of RSI (repeated stress injuries). One solution is to minimize mouse use by providing “short-cut” keys. However, such keys may be numerous, different for different applications and require a significant learning period.

An additional concern is the needs of handicapped people. The operation of two different devices, a keyboard-equivalent device and a mouse-equivalent device may be too demanding for many handicapped users.

With the spread of embedded computers and mobile devices, there has been a rise in the number of devices that do not include a mouse but do include a graphical display. In such devices, there is generally a need for a convenient method of graphical pointing.

U.S. Pat. No. 5,485,614 to Kocis, “Computer with Pointing Device Mapped into Keyboard,” whose disclosure is incorporated herein by reference, describes a computer architecture in which a keyboard is used to control both the text cursor and the pointing cursor. In essence, the pointing cursor is controlled by the arrow keys of the keyboard together with one or more other keys. The arrow keys thus direct the cursor in a specific direction (up, down, diagonal to top left, etc.) relative to the current position of the pointing cursor. This method requires, on the average, many keystrokes for each cursor movement and therefore may be time-consuming and tiring. This type of control is relative control, in which the keyboard commands move the cursor relative to its previous position. In contrast, in a touch screen, the control is by absolute addressing—the cursor is moved to the location pointed to by touching the screen.

U.S. Pat. No. 5,019,806 to Raskin et al., “Method and Apparatus for Control of an Electronic Display,” whose disclosure is incorporated herein by reference, describes a method of designating a text region on a display of a text based application. Raskin et al. use a first and a second designation keys coupled to a processing unit which searches for a pattern entered into a keyboard while one of the designation keys is activated. The processing unit searches the display and the memory for the pattern, and brings the cursor to it. Raskin's system is useful only when it is desired to bring the cursor to a point that can be described by keystrokes. Furthermore, Raskin's method is concerned with designating regions within one application, controlled by the keyboard. A display may contain several applications. Finally, Raskin's method is concerned with bringing the cursor to specific points within a document, whether they currently appear on the display screen or not.

### SUMMARY OF THE INVENTION

An aspect of some exemplary embodiments of this invention relates to assigning address codes to a plurality of points on a display screen, and accessing the points using the assigned codes. In an exemplary embodiment of the invention, the codes are screen-oriented and not application oriented, in that the same interface is used for all and any applications, and even if there are several application windows open simultaneously. However, in some implementations, the codes and/or other features of the invention may be limited to a single window or a single application. In an exemplary embodiment of the invention, the address codes relate to the visible part of the screen and not hidden parts, for example unscrolled portions of windows. Optionally, but not necessarily, the address codes are direct access codes that refer to an absolute, rather than relative position. In an exemplary embodiment of the invention, at least 10, 20, 40, 100 or even 200 or more different locations on the screen can be addressed by different addresses.

In some exemplary embodiments of the invention, the codes are assigned responsive to the current contents of the display. In an exemplary embodiment, in display areas that comprise text, each character of that text serves as a temporary-text code, or address, for the screen area on which it is displayed. In some embodiments of the invention, the characters are not limited to printable ASCII characters. Possibly, a mapping between addresses and display elements or icons is provided, for example to allow window manipulation using the display addressing scheme.

Optionally, the codes are assigned responsive to partial address entry by a user, for example, all screen locations that include the partial address are tagged with suitable codes.

Alternatively or additionally, the codes are assigned without relation to the contents of the display. Optionally, the screen is divided into a plurality of areas, which are assigned area-designation codes. The area designation codes are optionally fixed throughout a work session, but may change upon a user's request. Optionally, an iterative approach is used, in which a user progressively fines tunes the screen position.

Optionally, the codes comprise one or more alphanumeric characters and symbols for which a standard ASCII conversion is available and especially optionally characters which are easily and/or conveniently generated using a standard keyboard. Alternatively, a color code, or gray-level code, for which a special ASCII (or keystroke) conversion may be developed, is used. In an exemplary embodiment of the invention, the screen mapping matches the geometric layout of the keyboard, for example a QWERTY or a Dvorak layout. Alternatively, an intuitive layout, such as ordered alphabetic, may be used.

Alternatively or additionally, the address codes are entered using non-keyboard means, such as using a pen or using voice entry.

In an exemplary embodiment of the invention, the present invention is used for providing graphical pointing capability for devices that have a limited or no such capabilities, or in which a designated pointing device cannot be used for a significant portion of time. Two exemplary classes of such devices are thin client devices and embedded devices. Specific examples of such devices are set-top boxes and digital TVs, cellular telephones, palm-communicators, organizers, motor vehicles and computer-embedded appliances.

An aspect of some exemplary embodiments of the invention relates to a method of absolute control of a cursor position, optionally using a keyboard. In an exemplary embodiment of the invention, the cursor is moved directly to a point of interest, without requiring an iterative process of control by the user coupled with visual feedback from the screen to determine if the correct motion has occurred. As used herein, a point of interest is a screen object that can be manipulated, for example a button or a screen object that can be selected, for example text. In an exemplary embodiment of the invention, the desirability of a symbol as a point of interest is determined in a hierarchical manner, for example, any symbol is more interesting than a blank background and icon symbols are more interesting. In an exemplary embodiment of the invention, the interest level of a point is determined by analyzing its screen appearance, for example color (e.g., many browsers use different colors for active links), text contents (e.g., the word “go” or “http:/”) indicate activity, image contents (e.g., a particular feature of an image) and/or geometry (e.g., icons). In an exemplary embodiment of the invention, a dictionary of useful keywords and geometric shapes is used by the program. In an exemplary embodiment of the invention, geometric pattern matching or feature extraction, rather than bit-for-bit matching are used to detect symbols of interest.

An aspect of some exemplary embodiments of this invention relates to providing a method for correlating keys strokes of a standard computer keyboard (or voice input) with address codes of the display screen. An operational mode is thus provided in which striking a key or a key combination means: “Refer to this address on the display screen.”

Optionally, where a temporary-text code is used, typing a portion of text means: “Refer to the area of this text on the display.” For example, typing “SUMMARY OF THE INVENTION” will mean: “Refer to the title to this section, on the display.” Alternatively, where an area-designation code is used, each with a correlated key or key combination, striking the proper keys will reference the desired area For example, when a color code is used, striking Ctrl B may move the pointing cursor to a blue area, and striking Ctrl Y may move the pointing cursor to a yellow area. Optionally, when there are a plurality of areas (or points of interest) with the same address code, entering the code moves the cursor to the next area having the address. Alternatively to entering text using a keyboard, other means may be used, for example speech input or handwriting input means.

An aspect of some exemplary embodiments of this invention relates to providing methods for fine tuning the addressing using a limited number of codes. Alternatively, these methods may be used to reduce the scope of search for a point to which a cursor movement command refers or needs to refer to in a subsequent step. In an exemplary embodiment of the invention, the fine tuning is by automatically determining a point of interest in the addressed area and optionally providing a user with means to jump between such points of interest. Alternatively or additionally, the fine tuning is by sub-addressing the first addressed area. Alternatively or additionally, the fine-tuning is by applying a different addressing scheme, possibly even a relative cursor control scheme in that area In an exemplary embodiment of the invention, the addressed area is enlarged on the screen for repeated iterations, so that the screen area associated with each code can be made as small as desired down to the size of one pixel.

In an exemplary embodiment of the invention, when a partial address is entered, an index is generated that lists all the possible completions or matches to the address. For example, typing “s” will index all the words starting (or finishing) with an “s”. Each such word may be tagged, on screen, for example, with an index term, for example one of the digits, letters or other keyboard character. Typing that character will bounce the cursor to the indexed word. Optionally, in this and/or in other embodiments, the partial address and/or the index are entered using a voice modality.

An aspect of some exemplary embodiments of the invention relates to displaying an address map on a screen. In an exemplary embodiment of the invention, the map is shown as an overlay that does not hide large blocks of display. Optionally, thin characters and/or lines are used for the map. Alternatively or additionally, the characters are displayed in a manner which minimally corrupts the underlying display, for example using embossing. In an exemplary embodiment of the invention, the address map comprises a division of the display and one or more characters for each section. Optionally, the subdivision lines and/or the exact address location are shown.

Alternatively or additionally, the map comprises tags for objects that can selected by further keystrokes.

An aspect of some exemplary embodiments of the invention relates to using absolute addressing techniques in conjunction with gaze tracking and/or voice input. In an exemplary embodiment of the invention, these methods are used to limit the area to which an absolute addressing command can refer to. Alternatively or additionally, a speech recognition circuit may be used to input the address for an absolute addressing scheme. Alternatively, these alternative pointing methods may be used to provide a gross pointing resolution, while keyboard methods as described herein are used for fine tuning the pointing. Alternatively, the keyboard entry methods are used to limit the interpretation of the alternate pointing methods, for example, limiting a determined gaze direction to match the direction to certain symbols or text words.

An aspect of some exemplary embodiments of the invention relates to a method of embedding information in a displayed image, in which the information is encoded in low significant bits of the image. In an exemplary embodiment of the invention, this information comprises a description of the image content. Optionally, several descriptions for different image parts, with coordinates for each such image part, are provided. Alternatively or additionally, the information comprises an encoding of the text content of the image, so it can be read out without resorting to OCR techniques.

An aspect of some embodiments of the invention relates to utilizing a knowledge of the screen contents, in order to facilitate screen navigation. In an exemplary embodiment of the invention, a single set of “short-cuts” are defined between applications, by assigning fixed addresses for various icons, keywords, menu items, window controls and/or other display objects. Thus, when a user enters the address for the “print” icon, the same address can apply irrespective of which application window is open. Indexing and/or other methods of selecting between multiple matching screen locations may be used to select one of several displayed print icons.

Alternatively or additionally, by defining a dictionary of “interesting” screen objects, navigation, relative or absolute, can be facilitated. In one example, the courser keys jump from one “interesting” object to the next, based on its screen location, independently of the actual applications windows. In one example, a set of “interesting objects” includes keywords, icons, desktop icons, window controls and menu bar items. The ability to thus navigate may be based on a knowledge of what is on the screen and/or on an analysis of screen contents. In another example, a mouse pointer can be modified to “stick” only to interesting objects. In a mouse example, each mouse motion, or duration of motion, or above-threshold amount of motion is translated into one step in the mouse motion direction.

Optionally, the granularity of navigation and/or selection is dependent on the screen content, for example, in an area of text, selection is per character, in a graphic area, selection is per graphic item, with text words being selected as whole units. The content of an area may be determined, for example, if over a certain percentage of display objects in that area are of a certain type and/or based on the percentage of screen coverage.

There is thus provided in accordance with an exemplary embodiment of the invention, method of indicating by a user of a screen location, on a system having a screen displaying content, comprising:

entering at least a partial screen address, defining an absolute position on said screen, wherein said screen address can indicate substantially any location on said screen;

determining a screen location corresponding to said at least a partial address; and

pointing, by the system, to the screen location indicated by the at least a partial screen address. Optionally, entering comprises typing on a keyboard. Alternatively, entering comprises typing on a keypad lacking individual keys for letters.

Alternatively or additionally, entering comprises entry by voice. Optionally, said voice entry comprises annunciation of characters.

In an exemplary embodiment of the invention, entering comprises entry by pen input.

In an exemplary embodiment of the invention, determining comprises matching said at least a partial location to an address of said screen location.

In an exemplary embodiment of the invention, determining comprises analyzing a content at said screen location to determine an address of said screen location. Optionally, said determining is performed prior to said entry. Alternatively, said determining is performed after said entry.

In an exemplary embodiment of the invention, each screen location has a fixed address, independent of content displayed on said screen. Alternatively, each screen location has a temporary screen address, is related to a content displayed at said location. Optionally, said temporary address comprises a description of said content. Alternatively or additionally, said address comprises a message embedded in said content.

In an exemplary embodiment of the invention, analyzing comprises analyzing at least one image displayed on said screen, for matching a substance of said image to said at least partial screen address. Alternatively or additionally, analyzing comprises analyzing text displayed on said screen, for matching said text to said at least a partial screen address. Alternatively or additionally, analyzing comprises analyzing at least one graphical object displayed on said screen, for matching said at least one graphical object to said at least partial screen address. Alternatively or additionally, analyzing comprises analyzing an indication associated with at least one graphical objects displayed on said screen, for matching said at least one graphical object to said at least partial screen address.

In an exemplary embodiment of the invention, said at least partial screen address is independent of the existence of one or more applications whose execution is displayed on said screen. Alternatively, said at least partial screen address is dependent on the existence of one or more applications whose execution is displayed on said screen.

In an exemplary embodiment of the invention, determining comprises fine-tuning said location responsive to user input after a first location determination. Optionally, said fine-tuning comprises:

associating an index tag with each of a plurality of potential screen locations; and

receiving a user input indicating which of the indexed screen location to select. Optionally, said plurality of potential screen locations includes a content of graphical objects that the screen addresses relate to.

Alternatively or additionally, said fine tuning comprises receiving a relative motion indication from said user. Alternatively or additionally, said fine tuning comprises receiving an absolute motion indication from said user. Alternatively or additionally, said fine tuning comprises providing a higher resolution screen address mapping than used for said entry. Alternatively or additionally, said fine tuning comprises receiving a user entry using an input modality other than used for said entry. Optionally, said entry input modality and said other input modality comprise speech input and keyboard entry.

In an exemplary embodiment of the invention, said fine tuning comprises using a different addressing method than used for said determining prior to said fine tuning.

In an exemplary embodiment of the invention, determining comprises fine tuning said location responsive to a content of said screen at said location. Optionally, said fine-tuning comprises determining at least one point of interest on said screen responsive to said at least partial address.

In an exemplary embodiment of the invention, said at least partial screen address is a single character. Alternatively, said at least partial screen address comprises at least two characters.

In an exemplary embodiment of the invention, said at least partial screen address comprises a first part corresponding to a first screen subdivision direction and a second part corresponding to a second screen subdivision direction.

In an exemplary embodiment of the invention, said at least partial screen address comprises a complete screen address.

In an exemplary embodiment of the invention, said at least partial screen address comprises only a part of a screen address.

In an exemplary embodiment of the invention, said determining stops at a first found screen address that matches said at least partial address.

In an exemplary embodiment of the invention, a complete screen address is unique for said screen.

In an exemplary embodiment of the invention, said determining automatically selects from a plurality of matches to the at least partial address.

In an exemplary embodiment of the invention, said method comprises manually selecting from a plurality of matches to the at least partial address.

In an exemplary embodiment of the invention, said method comprises providing a dictionary containing an indication associating at least one of an addressing possibility and an addressing priority of screen objects. Optionally, said screen objects include text words. Alternatively or additionally, said screen objects include icons. Alternatively or additionally, said screen objects include graphic objects.

In an exemplary embodiment of the invention, said dictionary defines a limited subset of screen objects as being addressable. Alternatively or additionally, said dictionary is personalized for a user.

In an exemplary embodiment of the invention, said method comprises displaying an indication of a mapping of screen addresses to screen locations on said screen. Optionally, said indication comprises a grid. Alternatively or additionally, said indication comprises a plurality of tags. Alternatively or additionally, said indication comprises a keyboard image.

In an exemplary embodiment of the invention, said indication is displayed using a gray-level shading. Alternatively or additionally, said indication is displayed using a color shading. Alternatively or additionally, said indication is displayed by modulating said screen content. Optionally, said modulating comprises inverting. Alternatively or additionally, said modulating comprises embossing.

In an exemplary embodiment of the invention, said displaying is momentary.

In an exemplary embodiment of the invention, said system comprises one of a desktop computer, an embedded computer, a laptop computer, a handheld computer, a wearable computer, a vehicular computer, a cellular telephone, a personal digital assistant, a set-top box and a media display device.

In an exemplary embodiment of the invention, said pointing comprises bouncing a text cursor. Alternatively or additionally, said pointing comprises bouncing a selection cursor.

In an exemplary embodiment of the invention, said method comprises receiving an entry from said user corresponding to a desired mouse action.

In an exemplary embodiment of the invention, said determining is limited to a part of the screen. Optionally, said part of a screen comprises a window.

In an exemplary embodiment of the invention, said determining comprises determining on an entire screen.

In an exemplary embodiment of the invention, said determining comprises determining in across windows of different applications on said screen.

In an exemplary embodiment of the invention, said screen addresses indicate said locations at a high spatial resolution.

In an exemplary embodiment of the invention, said screen addresses indicate said locations at a low spatial resolution.

In an exemplary embodiment of the invention, said screen addresses indicate said locations at a varying spatial resolution.

There is also provide din accordance with an exemplary embodiment of the invention, a method of navigating on a screen displaying a plurality of display elements, relating to a plurality of different applications, comprising:

defining a subset of said display elements to be relevant, including subset display elements from at least two unrelated applications;

receiving a user input indicating a relative motion, said input indicating a count and a direction; and

responsive to said user input, automatically selecting a subset display element of said subset that is distanced the inputted count of subset elements in the inputted direction; and

pointing to said selected display element.

There is also provided in accordance with an exemplar embodiment of the invention, a method of navigating on a screen displaying a plurality of display elements, relating to a plurality of different applications, comprising:

defining a subset of said display elements to be relevant, including subset display elements from at least two unrelated applications;

receiving a user input an absolute position, which is adjacent to some of said plurality of display elements; and

responsive to said user input, automatically selecting at least one subset display element of said subset included in said some of said plurality; and

pointing to said selected display element.

Optionally, defining comprises providing a dictionary of associations between display elements and addressability. Optionally, said dictionary is personalized for a user.

In an exemplary embodiment of the invention, said user input is provided using a mouse. Alternatively or additionally, said user input is provided using a cursor key. Alternatively or additionally, said user input is provided using a speech input.

In an exemplary embodiment of the invention, said method comprises determining a granularity of said selecting responsive to screen content around said display element.

### BRIEF DESCRIPTION OF FIGURES

Non-limiting exemplary embodiments of the invention will be described in following description of exemplary embodiments, read in conjunction with the accompanying figures. Identical structures, elements or parts that appear in more than one of the figures are labeled with a same or similar numeral in all the figures in which they appear.

FIG. 1A schematically illustrates a computer display on which exemplary embodiments of the invention may be applied;

FIG. 1B schematically illustrates a keyboard suitable for applying some exemplary embodiments of the invention;

FIGS. 2A-2D schematically illustrate several manners of dividing the display-screen into areas and referencing those areas, in accordance with several exemplary embodiments of the invention;

FIG. 3 schematically illustrates the division of the display screen of FIG. 1A into rectangles and the assignments of character addresses to each rectangle, in accordance with an exemplary embodiment of the invention; and

FIG. 4 schematically illustrates an enlargement of the contents of a specific rectangle to fill the display screen, the further division of it into rectangles and the assignment of characters addresses to each new rectangle, in accordance with an exemplary embodiment of the invention; and

FIGS. 5A-5D schematically illustrate, in a flowchart form, the steps in the execution of a mapping software, in accordance with an exemplary embodiment of the invention.

### DETAILED DESCRIPTION OF EXEMPLARY EMBODIMENTS

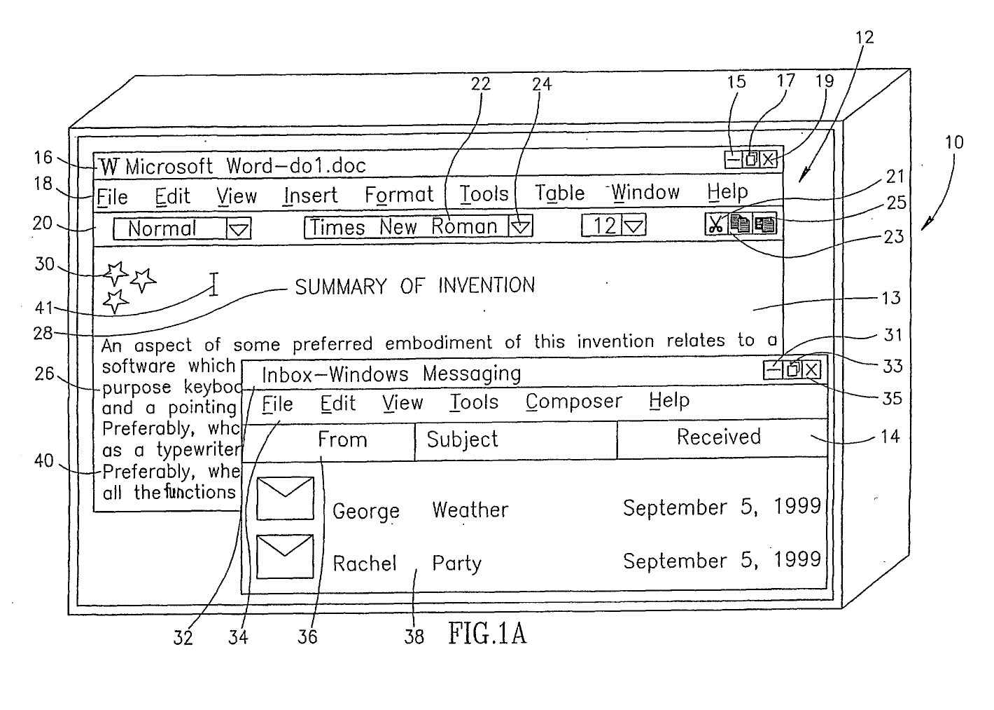

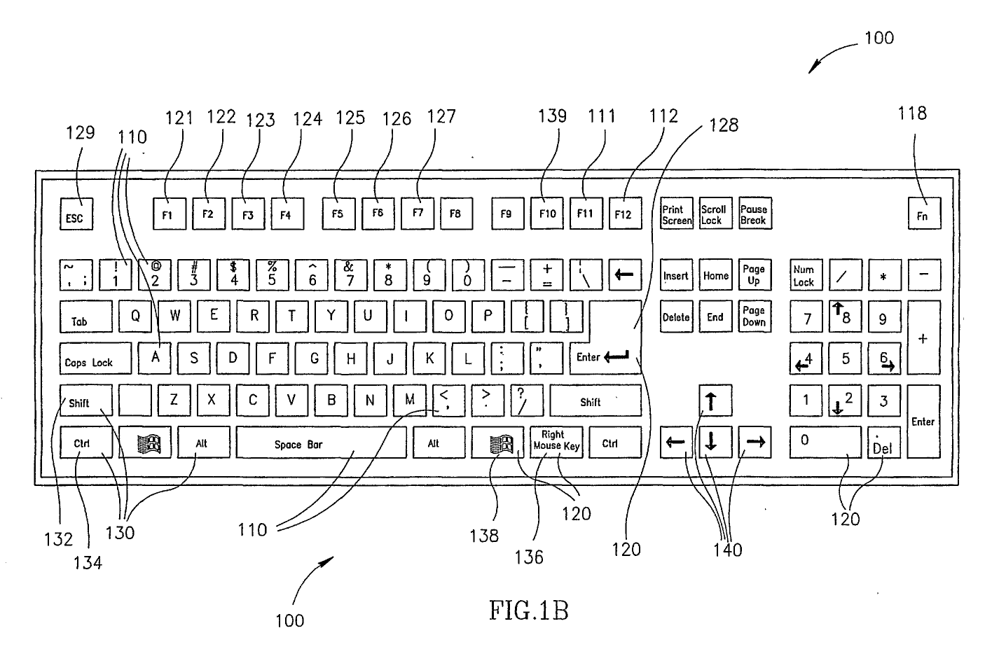

Reference is now made to FIGS. 1A and 1B which schematically illustrate parts of a computer system 10 comprising a display screen 12, a standard computer keyboard 100 and a computer (not shown). In accordance with some exemplary embodiments of the invention, computer system 10 does not require a mouse. Optionally, mouse-substitution is provided by the installation of a software in computer system 10 (henceforth, the mapping software), which converts standard keyboard 100 into a dual-purpose-keyboard by providing it with two operational modes. Optionally, in the first mode, a typing mode, keyboard 100 has the functions of a standard keyboard, and in the second mode, a pointing-clicking mode, keyboard 100 is used as a pointing device, to move a pointing cursor and/or emulate the clicking of buttons on a pointing device (e.g., “clicking”). Additional and/or hybrid pointing modes may also be defined, for example as described below.

It should be noted that two cursors are usually provided, a selection cursor 40, which is used to indicate the place where newly typed text will be inserted and a mouse cursor 41 which indicates the screen area referred to by the mouse. In many typical applications, clicking on the mouse when mouse cursor 41 is over a text portion will move text cursor 40 to the mouse location. The selection cursor may also be used to indicate a currently selected icon.

In the typing mode keyboard 100 optionally comprises four groups of keys:

keys 110 for typing alpha-numeric characters and symbols, such as: “a”, “5”, “:”, and “$”;

keys 120 for carrying out functions, especially general functions, for example editing, but also application specific functions, such as: Del, Insert, Enter (editing), Esc, F1 (application specific);

keys 130 that are used in conjunction with other keys to modify their meaning, such as: Shift, Ctrl, Alt; and

keys 140 for controlling cursor movement (both text and mouse, depending on the system mode), such as: Home, ←, ↑, Tab, Backspace.

In an exemplary embodiment of the invention, in the pointing-clicking mode, keys 110 (and possibly keys 130) are optionally used to address areas on the screen, keys 140 are optionally used to perform relative movements of the pointing cursor, and keys 120 are used to perform clicking actions and/or other editing actions. However, other key usage schemes may be provided. In particular, where a key stroke is suggested below, a key combination and/or a key sequence may be used instead.

In exemplary embodiments of the invention, any of keys 110-140 and/or combinations thereof may be used to toggle between the modes. Optionally, however, keys 130 are used for the toggling. In some embodiments, only one toggling direction is required, from text to pointing mode, as the mode snaps back, for example after a time delay in which no keys were pressed or after the pointing is achieved.

In some application software, some keys and/or key-combinations may already be defined to have a function. Optionally, this function is not overridden by the mapping software. One method of avoiding overriding is by defining a prefix key combination required to enter a non-standard keyboard mode. Alternatively or additionally, the assignment of keys for toggling and/or for the pointing mode takes into account common shortcut keys. Alternatively or additionally, a user may redefine key-functions so as to avoid conflict between application and the mapping software. Optionally a configuration utility is provided, for example for use during the installation of the software.

In some exemplary embodiments of the invention, certain key assignments of function keys 120 are maintained both for the typing mode and for the pointing-clicking mode. For example, a key 121 (F1) is generally used as “HELP”, and may be used as such both for other applications and for the software. In an exemplary embodiment of the invention, a key “Fn”, indicated by reference 118 is used for toggling, however, many keyboards do not include this key. Alternatively, a “right-alt” key (or other composition key) may be used for toggling, for example, by depressing it alone, possibly for a minimal defined duration. In some embodiments of the invention, for example in laptop computers, a dedicated toggle key 118 is provided. Optionally, other keys may be used for returning to a default mode (typing or pointing), for example, an “esc” key.

In an exemplary embodiment of the invention, the pointing clicking mode provides a direct addressing scheme, rather than, or in addition to a relative addressing scheme (such as provided using a mouse). Thus, the mouse cursor (and/or the text cursor) is optionally moved to a new location, rather than shifted in a certain direction by the keyboard. In some cases, fine tuning of the cursor location will be achieved using relative techniques, such as arrow keys.

In an exemplary embodiment of the invention, one or both of the following addressing schemes are provided:

a. a temporary-text mode, in which key-presses are used to bounce the cursor to matching text on the display, and

b. an area-designation mode, in which each screen area is mapped to a specific key or keys.

c. an indexing mode in which points of interest on the screen are tagged with an index, for example, responsive to the entry of a partial address (of any type).

In an exemplary embodiment of the invention, one of the modes is designated a default mode which the mapping software uses to translates the key strokes. Alternatively or additionally, a user may define using a certain key stroke (or key strokes) which mode to enter. Alternatively or additionally, the last used mode may be defined as a default. Possibly, one of the key combinations is used to open an interaction window in which a user can define the default and/or the current behavior of the mapping software.

In an exemplary embodiment of the invention, in the temporary-text mode, when the user enters a string of text using one or more keystrokes, cursor 40 bounces to the location of the string on screen 12. For example, as we look at screen 12 in FIG. 1A, cursor 40 is located near a word “Preferably”. To bring the cursor to a title 28 the user will type: “SUMMARY”, whereupon, cursor 40 will bounce to title 28, optionally to the bottom left corner of it. Alternatively, cursor 40 may bounce to the right of it, or to another point in relation to it. Optionally, the string is treated as a set of characters, whose order is not important. Alternatively or additionally, a user may enter a pattern (e.g., including wildcards), rather than a string. Some wildcards may represent icons or other graphical elements, rather than letters.

Alternatively or additionally, to bouncing text cursor 40, the pointing cursor 41 may be bounced. Optionally, a certain keystroke (which may emulate a “click”) may be used to make the two cursors match-up. In an exemplary embodiment of the invention, the cursor does not select the entered text, when it moves. Alternatively, the cursor does select the text. Possibly, the selection behavior and/or positioning relative to the word is determined by user entered defaults or by the user pressing a certain key.

The cursor may begin moved as soon as the user starts typing keys. Alternatively, the bouncing may wait until there is a pause in typing. In an exemplary embodiment of the invention, as the user types more keys, the cursor is moved to the nearest sequence which matches all the typed keys. Optionally, the user ends the string with a special key, for example, key 128 (enter).

Optionally, as a default case, the computer assumes that keystroke entries apply a new string. When the user wishes to extend a previous string (from a previous pointing or after a certain delay), the user indicates this by a special keystroke, for example, a key 123 (F3). Alternatively, one special keystroke will precede a new string, and another will precede a continuation of a previous string. Alternatively still, the computer will pose a written question, for example, “New string?”. Optionally however, the software automatically determines if a current keystroke is a continuation or a new string, for example, based on a time out or based on activities of the user between the two keystroke sets. Alternatively or additionally, a time out may be used to switch back to a default mode, for example a normal typing mode.

In some exemplary embodiments of the invention, a third option “Next string” is also available, either by a special keystroke, for example, a key 124 (F4), or in response to a computer question. The selection of this option will bounce the cursor to the next string on display screen 12, which matches the keystrokes. Alternatively or additionally, other methods of choosing between two matches are provided, for example, by the computer posing a question or by the cursor blinking between the matches until the user presses a key. Alternatively, an indexing method, as described below, may be used.

Optionally, when scanning the display screen for a string, the computer begins scanning from the top left corner, and scans first across, a line of text, then down one character. Alternatively, especially where a language that is written from left to right is used, the computer begins scanning from the top right corner. Alternatively, the computer begins scanning from the top left corner, and scans down a line of text, then to the right one character. Alternatively or additionally, the scanning starts from the current text location. Possibly, the scanning is spiral. Alternatively, any other order of scanning maybe used.

In an exemplary embodiment of the invention, the search is case sensitive. Alternatively, the search is case insensitive. Possibly, a special key is provided to indicate a language of the text to be matched. Alternatively, the language may be determined from the computer settings and/or based on the displayed text and/or characters. Optionally, non-ASCII characters and/or icons may be represented using keystroke combinations. These features may also be controlled using user defaults. Optionally, the keyboard mapping changes, responsive to the language mode the computer or window are in and/or responsive to the major language displayed on the screen.

Accessing an icon may follow the regular rules, as applied to the associated text. Alternatively, the user may limit his addresses to those referring to icons, window controls, menu items and/or other screen display object subsets, for example, by entering the address with an indication (e.g., a special key stroke or the key sequence “icon”) that it is an icon address. In an exemplary embodiment, a trio of keys, such as “print screen”, “scroll lock” and “pause” represent the icons in the upper right corner of a window in a Windows95 window.

Optionally, a display may be provided to show the keystrokes entered by the user. Alternatively or additionally, text editing keys, such as “backspace” may be used to “edit” the entered keystrokes and thus modify the screen address represented by them. A standard key, such as “esc” may be provided to cancel the current mode and/or the last entry and/or sub-mode change (e.g., screen enlargement).

In an exemplary embodiment of the invention, address codes for the area-designation mode are provided by the software. In an exemplary embodiment of the invention, the keyboard layout is mapped to the screen or to a portion thereof, so that each key corresponds to one or more screen areas. It is noted that the keyboard has more columns than rows. In an exemplary embodiment of the invention, the keyboard is mapped to a third of the display. In an exemplary embodiment of the invention, the user can select, for example using a certain key stroke or based on the user's previous position, which screen portion is being addressed. Alternatively or additionally, the mapping moves on the screen, for example, once for each keystroke.

In an exemplary embodiment of the invention, a map of the keyboard is overlaid on the screen to indicate the address codes to a user. The over-laying may be immediate when entering the mode, after a delay or possibly, responsive to a particular key stroke. Alternatively or additionally, other address designations, such as a grid designation, may be used, in which case the address indications may be relegated to the sides of the screen.

In an exemplary embodiment of the invention, the characters are embossed on the display, so that they minimally interfere with reading the display. Alternatively, other display methods, such as inverse-video, may be used. In different embodiments different character sizes, fonts and styles may be used. In particular, an outline character may be used.

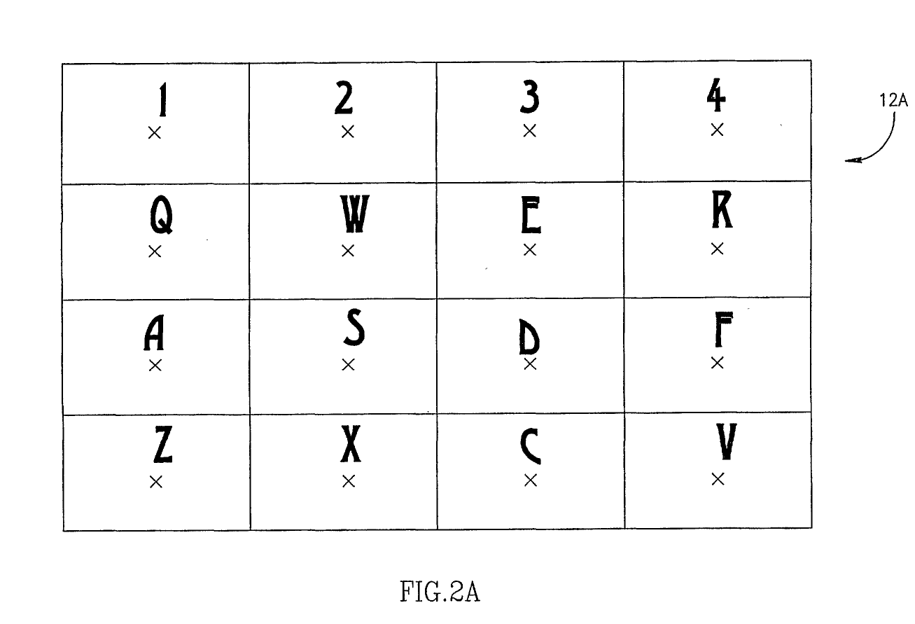

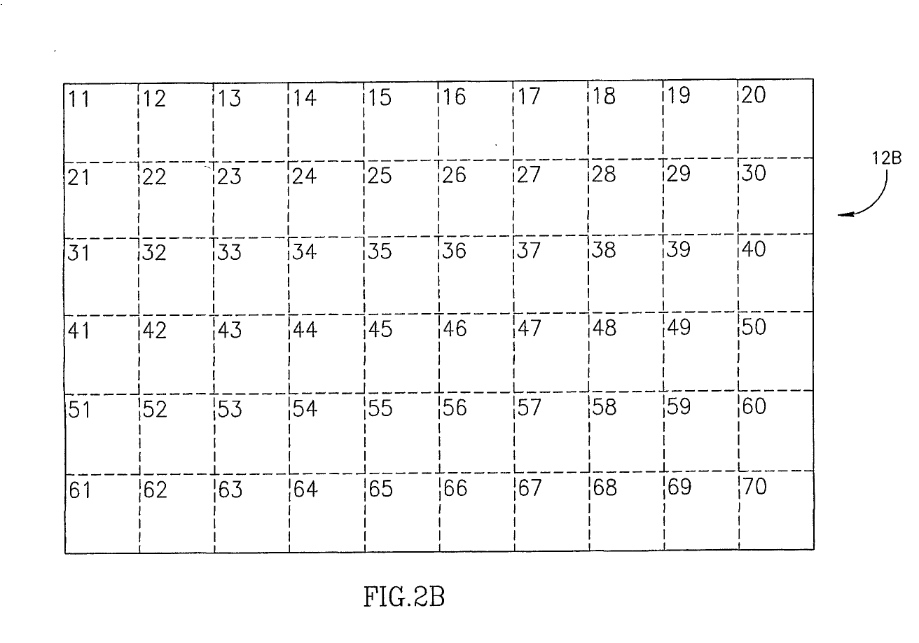

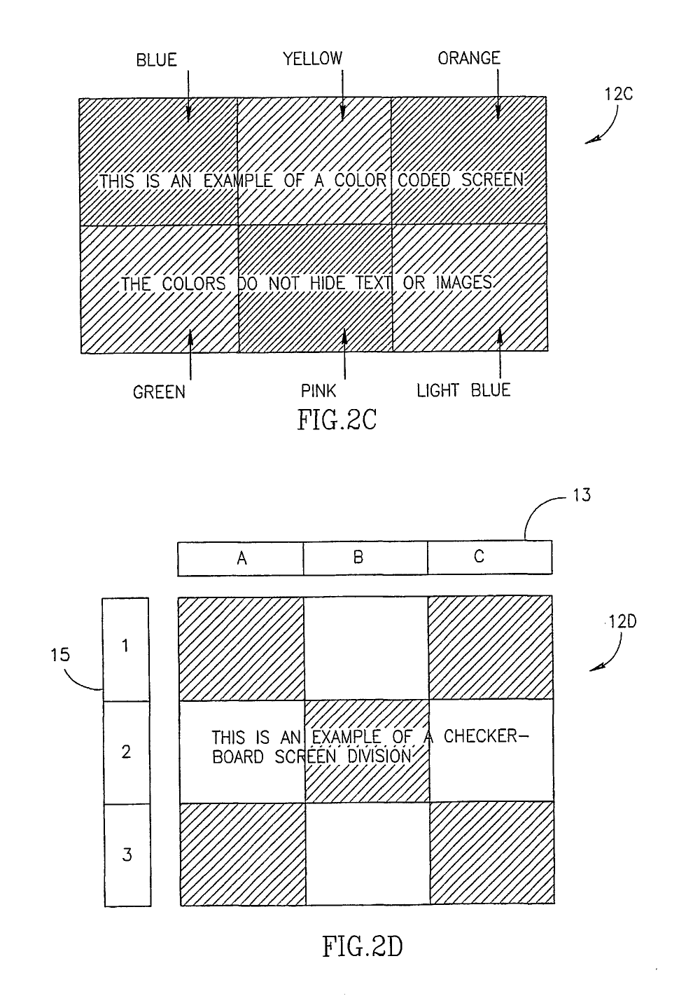

Reference is now made to FIGS. 2A-2D, which illustrate several manners of address assignment and superimposing characters on a display screen, in accordance with some exemplary embodiments of the present invention. It should be noted that although these techniques may be applied to a single software application or application window, in an exemplary embodiment of the invention, these techniques are applied to the screen as a whole, without reference to the underlying windows and/or applications, except to the extent in which they might aid in temporary text addressing techniques.

FIG. 2A illustrates a display screen division in which the screen is divided into 16 rectangles, each marked by an alphanumeric character that references its center. The marking may reference other parts of the rectangle instead, for example its upper right cornet. Alternatively or additionally, the marking may be changed by setting up defaults and/or by applying a suitable keystroke.

In an exemplary embodiment of the invention, the screen division matches the physical keyboard layout, for example a QWERTY or a Dvorak layout, however, this is not essential. In some embodiments, the layout is vertically repeated, as the aspect ratio and/or spatial resolution of the keyboard does not match that of a screen. A special key may be provided for selecting which part of the screen is mapped by the keyboard. Alternatively or additionally, the layout is horizontally repeated. Optionally the screen division is in a grid shape, however, the screen division may also be non-grid, for example, exactly matching the keyboard geometry. This may require a user to select the model of keyboard that he uses, from a list during a configuration stage.

It is noted that geometric shapes other than rectangles and/or other numbers of rectangles may be used. The aspect ratio of the rectangles may be the same as the screen or it may be different. The reference point may be marked or unmarked. In some cases, more than one character is needed to reference each rectangle. FIG. 2B illustrates a screen division to 10×6 squares, each marked by an alpha-numerical character sequence that references its upper left corner. FIG. 2C illustrates a color-coded screen division, in which the addressed areas are differentiated by using different colors. Colors will generally not mask the text or images on the display screen. FIG. 2D illustrates a checker-board pattern of light gray and white, referenced by alphabetic characters on a top ruler 13 and numeric characters on a side ruler 15.

The same or different sets of characters may be used for the two axes. If different ones are used, the address designation may be entered in any order and even corrected by typing a new key. Grid lines may be shown or not. Various combinations of the above methods and/or other addressing methods may also be used.

In an exemplary embodiment of the invention, the addressing grid conforms to the location of objects of interest on the screen, for example, icons on a desktop, menus and window controls. This may include shifting of the grid, distorting the grid and/or varying the resolution of the grid for different parts of the screen. Alternatively or additionally, only objects of interest are tagged, with addresses that can be shown on the screen.

When a column or row is selected, the entire selected row or column may be marked. Similarly, when a cell is selected, the cell may be marked and/or highlighted.

In some cases, no screen display of the mapping is needed, as a user may remember the screen mapping and/or use the feedback from the cursor movement to correct his pointing activity.

As can be appreciated, the pointing resolution using keyboard-mapping may be insufficient for certain uses. In an exemplary embodiment of the invention, various mechanisms are provided for fine-tuning the pointing. Alternatively or additionally, the pointing location is automatically corrected to a portion of the addressed area, based on the content of the area.

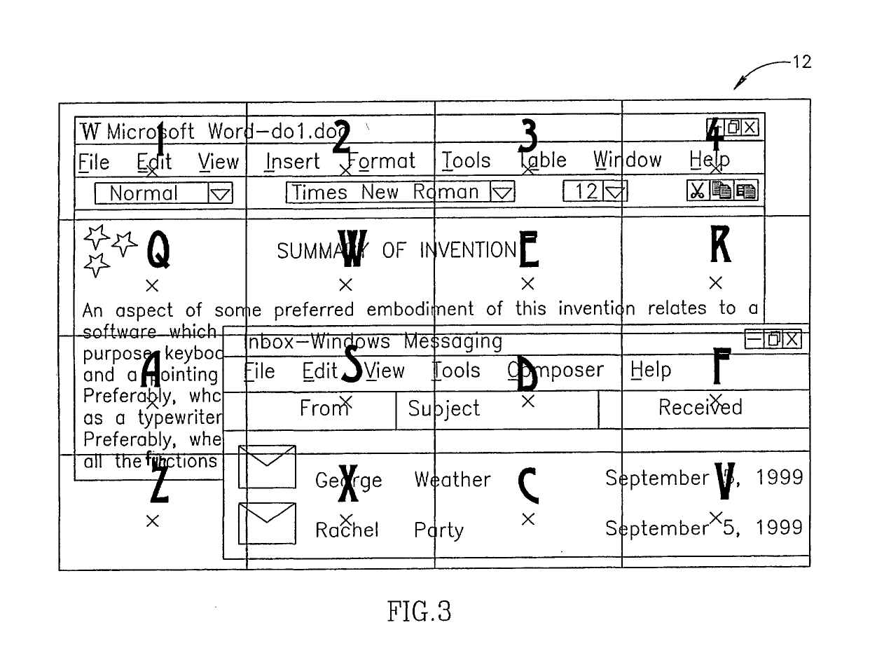

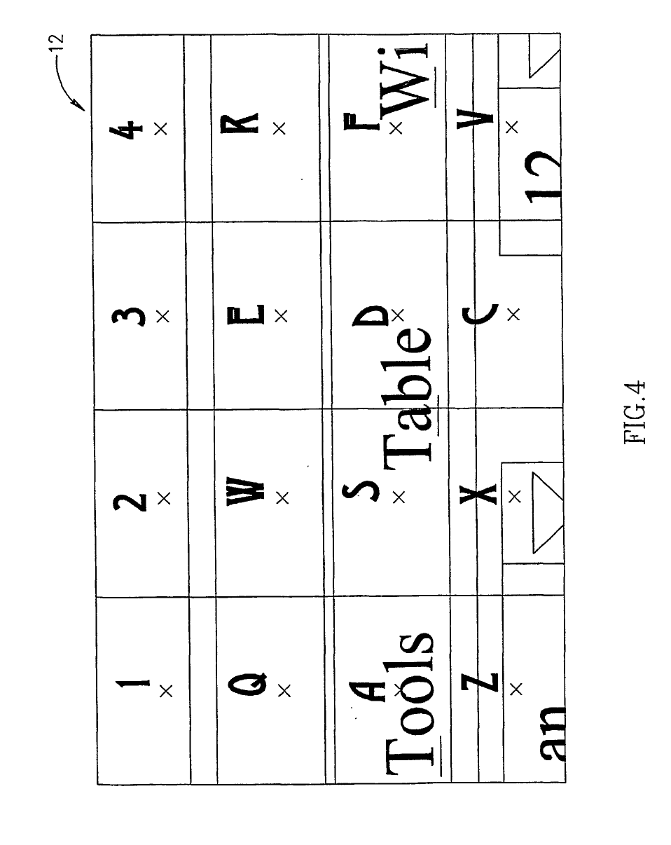

Reference is now made to FIGS. 3 and 4, which illustrate a method of fine tuning in which the screen is enlarged after an area is addressed. Optionally enlarged screen 12 is re-divided using a same scheme as used to address the area, for example into 16 rectangles, using the same letter-addresses. Alternatively, a different mapping scheme may be used, for example, using different letters or even a different addressing scheme. Thus, for example, letters may be used for main-areas and numbers for sub areas. Once the screen is enlarged, the addressing method can remain the same or it can be changed, for example from a temporary-text scheme to a direct addressing scheme. Optionally only two levels of resolution are required, however, in some embodiments more levels are provided and may be accessed, for example using a special key, such as a key 126 (F6).

In some embodiments, the grid is made finer alternatively or additionally to actually enlarging a portion of the screen. Optionally, a finer grid and/or an enlargement “pop-up” when a partial address is entered and no selection is made.

In one example, if the user wishes to change a font size, he will strike the “3” key to reach the font size box, whereupon the cursor will bounce to the rectangle designated by “3”, to the “size” window, which is the most relevant area for text input. Thus, a zooming step is possibly not required. Alternatively, rectangle “3” (and/or nearby rectangles) is enlarged to fill the whole of screen 12 as shown in a FIG. 4. The user can strike the “J” key to reach the font selection window. As FIG. 4 shows, the cursor may bounce to a point near, but not quite on a black triangle of the font selection window. In an exemplary embodiment of the invention, the mapping software causes the cursor to be attracted to a nearest useful graphical element or point of interest. Thus, when striking “J”, the cursor will be attracted to the black triangle of the font selection window.

Typically, the useful elements are those that can be activated, such as buttons and other user interface objects or those that can be selected, such as text and/or graphic lines. In an exemplary embodiment of the invention, the interest level of a symbol or image portion is determined by analyzing the display presentation of the symbol, for example text (e.g., as compared to a dictionary of keywords), color shape and/or combinations thereof.

Upon reaching the desired point, a user may emulate a click (or double-click) with a left mouse key, for example, using a key 138 (Window key). Alternatively, he may highlight an area between a previous left-mouse click and a current cursor position using a same or a different key stroke, for example with a key 132 (Shift)+key 138. Alternatively or additionally, the user may emulate a click with a right mouse key, for example, using a key 136 (Right mouse key). Alternatively or additionally, the user may request a shortcut key to the position of cursor 40, for example, with a key 127 (F7).

As noted above, the mapping software may include a “sticky point” feature in which an address location is automatically fine tuned to the nearest item which might be manipulated by a mouse, for example an icon, a link or a button. Shifting between several relevant items may be achieved, for example using a key such as “Tab”. In an exemplary embodiment of the invention, the identification of the items is by analysis of the screen frame-buffer memory or by tracking the operation of functions that draw or write to the screen. Optionally, a hierarchy of importance between such items is defined, to assist in automatically selecting the most relevant object. Alternatively or additionally, tabs or other mechanisms are provided for jumping between displayed objects, for example words.

In an exemplary embodiment of the invention, the set of objects that can be selected between is defined by a dictionary. In one example, a direct address is limited to words that appear in a dictionary. Such a dictionary may be global, per application or operating system and/or provided by a user.

Another optional feature is the identification of text in images, for defining temporary text address codes for an image or portions thereof. In an exemplary embodiment of the invention, if a text string is not found, or possibly even if one match is found, image portions of the screen are analyzed to determine their text content, to allow a user to bounce the cursor to them. Such “embedded” text is common, for example in Internet images and in icons. Many methods of OCR are known in the art and may be used to detect such embedded text. In an exemplary embodiment of the invention, a degraded OCR is used, which only matches the image to the search string and does not attempt to extract the complete text string if it appears not to match the search string.

Alternatively, in an exemplary embodiment of the invention, the image may include therein an encoding of its content. In one example, such encoding is achieved by modifying the LSB bits of the image, for example 2 bits in a 24 bit image. The encoding may include, for example, the text content of the image or description of objects shown in the image. Optionally, the description includes coordinates and/or extents of the objects. Thus, the required information is available in the frame buffer. In one example, an image including a horse may include an embedding of the text “horse”. If a user types “horse”, the cursor will move to the image of the horse. Such embedding of information may be used for uses other than cursor control, for example for selecting from a menu which includes a textual description of the images or for generating such a menu. Alternatively or additionally, object recognition techniques may be used to generate the embedded text, or, similar to the OCR techniques described herein, to allow matching a text input to the image. Alternatively, a user may enter a description of screen objects, such as “hexagon” or “angle”, and screen objects matching these descriptions will be recognized by the cursor movement software, for example by tracking graphical drawing commands or by using feature recognition software.

The following is a summary of an exemplary assignment of functions to keys in accordance with an exemplary embodiment of the invention. However, the invention does not require all these key assignments or even the functionality of the keys. In some embodiments, only some of the functions are provided and/or different key-assignments are used.

1. toggle key “CHANGE OPERATION MODE” toggles between the typing mode and the pointing clicking mode—key 118 (Fn);

2. “LEFT-MOUSE CLICK”—key 138 (Window Key);

3. “HIGHLIGHT CLICK”, to highlight an area between a previous left-mouse click and a current cursor position—key 132 (Shit)+key 138

4. “RIGHT-MOUSE CLICK”—key 136 (Right-Mouse Key);

5. “AREA-DESIGNATION-POINTING-MODE” tells the computer to point by area-designation—key 122 (F2);

6. a “RETURN-TO-TEMPORARY—TEXT-POINTING-MODE”, a key 125 (F5);

7. an “AREA-DESIGNATION” key —any of keys 110;

8. “ENLARGE SCREEN” key—key 126 (F6);

9. “CONTINUE STRING” key—key 123 (F3)

10. a “STRING CHARACTER”—any of keys 110;

11. “END STRING” key —key 128 (Enter);

12. “NEXT STRING” key —key 124 (F4);

13. “SHORTCUT-ASSIGNMENT” key —key 127 (F7).

14. “HELP” key —key 121 (F1)

Optionally, a keyboard overlay or key caps (or stickers) in a set, are provided to mark the new functions of the keys. Alternatively or additionally, additional designated keys may be provided, for example in new keyboards or in laptop computers. Optionally, keys for specific activities may be arranged in a manner that mimics their screen appearance, for example, keys for controlling a window in the operating system Windows95, are arranged in a trio, in the order of “minimize”, “change size” and “close window”. A nearby key may be marked “move”. The keys may be so marked, as well.

Alternatively, keys with changing displays (on them or near them), for example miniature LCD or LED displays are used to show the instant or possible function of the key.

Let us follow an example, in which a user has just checked his e-mail, as illustrated in FIG. 1A, and now wishes to close a Windows Messaging document 14 and resume his work with a Word document 12. Assuming for the present example, the use of the shortcut key assignment delineated above, the user's procedure, can be as follows:

Step 1: Key 118 (Fn) to initiate pointing-clicking using temporary-text pointing mode;

Step 2: “xyz” (a string) followed by key 128 (Enter);

The computer will bounce the cursor to box 19 of Word, which is not the desired location.

Step 3: Key 124 (F4), to indicate, NEXT STRING.

The computer will bounce the cursor to box 35, the desired location; At this point the user will click with key 138 and toggle out with key 118.

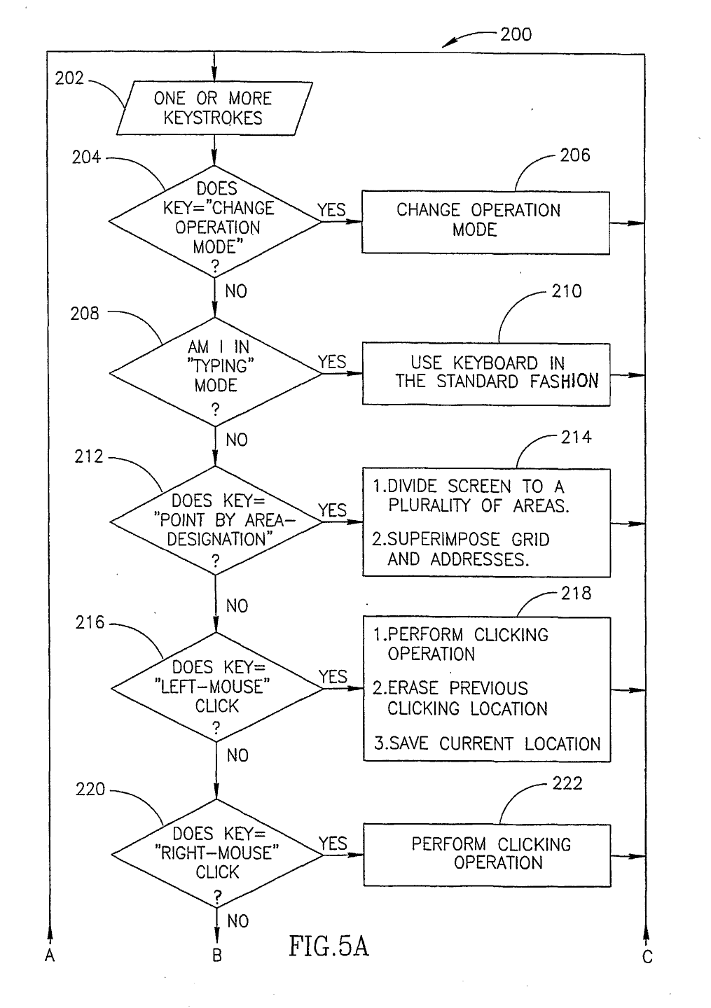

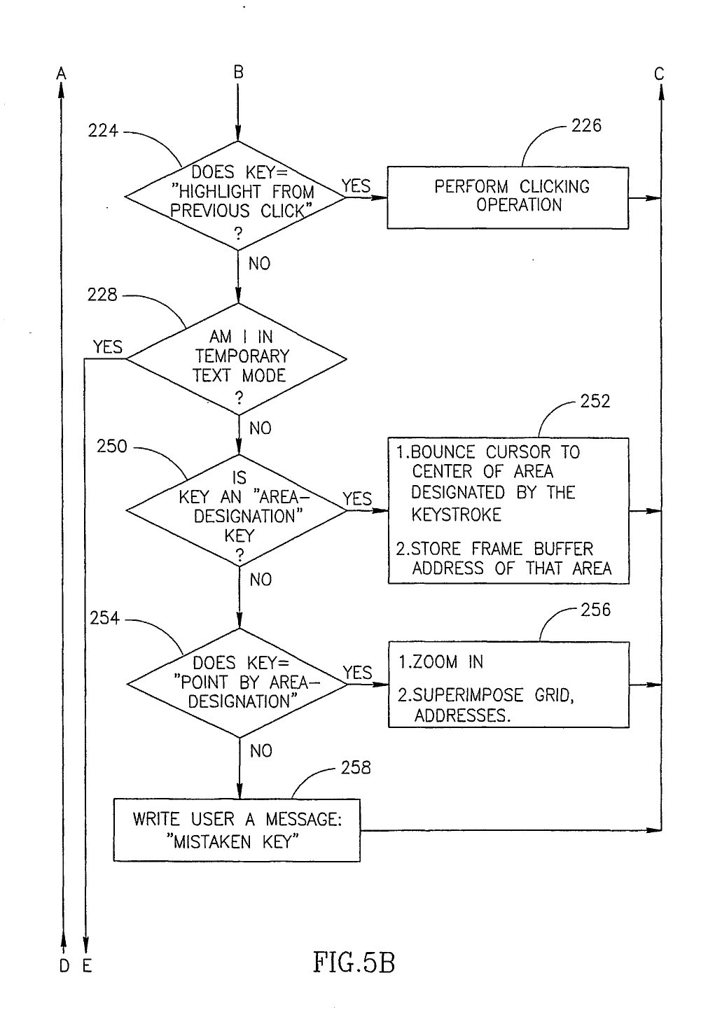

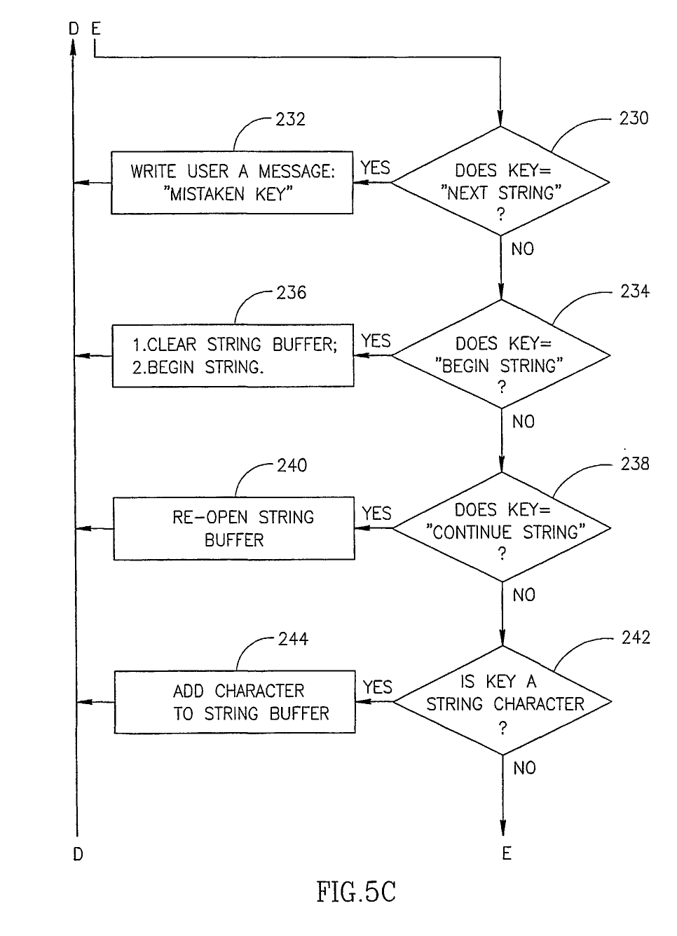

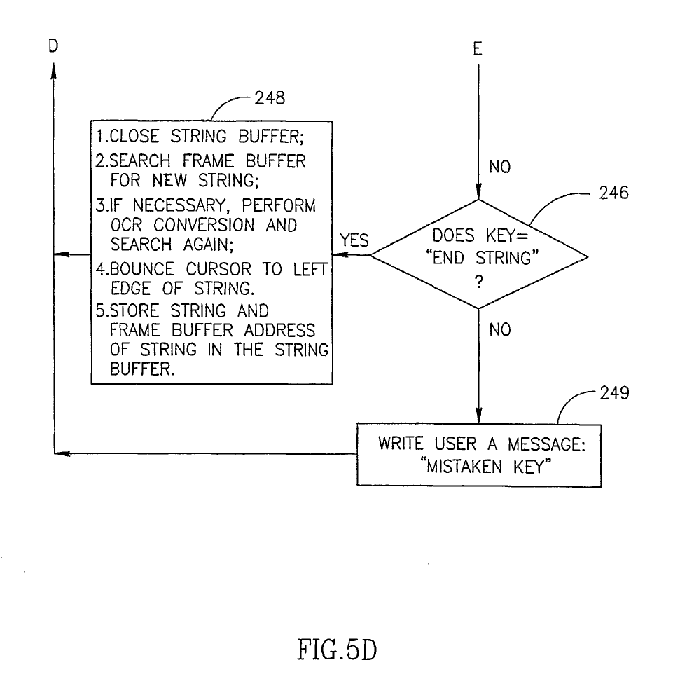

Reference is now made to FIGS. 5A-5D that comprise a detailed flow chart 200 for implementing one exemplary embodiment of the invention. Although many actions by the user are allowed in the flowchart, in some exemplary embodiments of the invention these actions are not performed, rather, a default is assumed or the possibility for action is blanked out, to facilitate simpler operation of the mapping software. Also, the order of the steps in the flowchart should not be considered limiting to any particular implementation, a person skilled in the art will appreciate that many orders can be used to effect exemplary embodiments of the invention as described above.

In general, the described process checks if the key is to be treated other than in a standard (prior art fashion), checks if the key is used to modify the mapping software behavior (and changes it) and then determines the address indicated by the key (and suitably moves the cursor). In some cases, the process is re-entered by a user applying a multi-key sequence. Optionally, the software remembers, at least for a certain minimum time, the state it was in after the last key was typed, to facilitate multi-key sequences.

First, a keystroke is entered (202).

Step 204 checks if the key changes the operation mode. If so, the mode of operation will be switched between the typing mode and the pointing-clicking mode, as described in a box 206, and the computer will wait for another keystroke.

If the computer is in typing mode (208) the key is transmitted (210) to an application program (or the operating system).

If the computer is not in typing mode, key is analyzed to determine if it is meant to modify the functionality of the mapping software or if it is an address code for the mapping software to use.

Step 212 checks if the key requests the area designation mode. If so, the computer will prepare the screen for the area-designation pointing mode (214), for example, by dividing the screen to a plurality of areas and superimposing a grid and addresses on the screen. The screen division is optionally static, however, it can be dynamically assigned. Dynamic division or assignment of addresses may be dependent for example on the keyboard language, since, in some multi-lingual systems, when the language is changed, some keyboard key mappings move.

In an exemplary embodiment of the invention, when this key, or its associated key, ENLARGE SCREEN, are not struck, the computer assumes that the temporary-text pointing mode should be used. Alternatively or additionally, when the enlarge screen key is struck, the mode is switched to area designation mode. Thus, the operational mode can follow the modifying keys of that mode.

If the key emulates a left mouse click (216), the clicking operation will be performed (218). Optionally, but not necessarily, a location of the click will be saved in a pointing buffer (not shown) for a possible region-highlight request by a future key entry. Optionally, the pointing buffer will save only one location, which will be stored over any previous clicking location in the pointing buffer. Alternatively, the most recent two, three, or some other selected number of previous locations will be stored in the pointing buffer, for example to allow shifting between pointer locations, even between applications. Optionally, the location that will be saved will be the frame-buffer address of a point on the screen where the clicking operation took place. Alternatively, when using temporary-text pointing mode, the location that is saved will be the temporary-text location, even thought its frame buffer address may have changed. Alternatively or additionally, a location relative to an enclosing window is saved.

If a right click is emulated (220), the right click will be performed (222).

If the key represents a highlight (or select) function (224), text and/or image portions may be selected, for example the area between the most recent left-mouse click (stored in the pointing buffer) and a present cursor location (226). Alternatively, different keys (or repetitions) may be used to emulate letter, word and sentence selection.

Also, a “drag” key and/or other keys that emulate mouse functions such as known in the art of mouse emulation, may be provided. Correct entry by a user of area addressing codes may be important, for example, if the entered keys are meant to emulate an area-selection function or a drag function of a mouse.

If the software is in temporary-text pointing mode (228), the left side of the flowchart applies, otherwise, the software is in area-designation pointing mode, and the right side of the flowchart applies.

In temporary text mode, if the key means “NEXT STRING?” (230), the computer will then bounce the cursor (232) to the next screen location of the current string and save the new frame-buffer address, optionally, over the previous address, in a string buffer (not shown).

If the key means “BEGIN STRING?” (234), the computer will clear the string buffer from a previous string and string address and instruct the string buffer to receive a new string, as described in a box 236. The computer will then wait for another keystroke.

If the key means “CONTINUE STRING?” (238), the next keystroke(s) are added to the string buffer to add any forthcoming characters to its existing string (240).

If the key is a printable character or one that represents a screen element (242), the character is added to the string buffer (244).

If the key means “END STRING?” (246), the string buffer is closed for updating and a search for the string on the screen is performed (248). If the string is found, the cursor is bounced to a location of the display screen associated with the string, for example, the bottom left corner of it. If the string is not found, the computer will perform an OCR conversion to any image stored in the frame buffer and repeat the search for the string. Optionally, an OCR conversion is performed with the first string request. Alternatively, it is performed when a pointing mode is requested. Alternatively or additionally, it is performed at regular intervals. Alternatively, the OCR it is performed on demand, when a string that was requested was not found in the frame buffer. When the string is found, the string and its current frame-buffer address will be stored in the string buffer.

Optionally, if the string is not found, the computer will print a message to this effect (249). Alternatively or additionally, a notification sound may be played. Alternatively or additionally, the cursor will not be moved.

Returning to step (228), if the mode is temporary text pointing mode, step 250 is performed.

If the key is an address for a screen area (250), the cursor is bounced to a point on the designated area, for example, the center of it (252). In some exemplary embodiments of the invention, areas are designated by more than one key, for example, “B5”. When the computer determines that it has received only a portion of the area designation, it will store that portion in an area-designation buffer (not shown) and wait for the remainder portion of the address before acting upon it.

If the key means “ENLARGE SCREEN?” (254), the screen will be zoomed around the area of the current cursor position (256). This area may then be divided and marked.

Optionally, if a key is undefined, the computer will print a message to that effect (258), play a sound and/or ignore the key. Alternatively, the software changes back to a standard keyboard mode.

In some exemplary embodiments, several keys may be struck one after the other, as one step, and the computer will check all these keys and perform the tasks associated with them, before waiting for another keystroke.

In some exemplary embodiments of the invention, the user may fine-tune a cursor position, for example using the arrow keys. Optionally, these keys move the cursor one character position, or a fixed number of pixels with each keystroke. Alternatively, the step sizes increase and/or decrease automatically, for example as a function of the time between presses or as a function of the count of the correction. In another example, on a tool bar, a tab will move the cursor to the next symbol, a backspace will move the cursor to a previous symbol, and an up or down arrow key will move the cursor to the upper or lower tool bar. Alternatively or additionally, the mapping methods described herein may apply to a toolbar or a set of toolbars, for example, each letter corresponding to a linear position along the toolbar.

In an exemplary embodiment of the invention, an indexing mode is provided. When indexing, a partial address (or even no address) are used to generate index-entries for all the relevant objects to be selected. The user can select a particular one of the relevant objects by entering its index value. In one example, typing “s” will select all the words starting (or ending, or containing) “s”, as relevant objects. Each such word may be assigned an index, for example a single digit or character or a numerical code. In an exemplary embodiment of the invention, digits and function keys are used as index entries. Typing the index code will bounce the cursor to the particular word.

Optionally, keys that may comprise a rest of an address (e.g., letters or digits, depending on the screen contents), do not form index entries. Alternatively, in some applications, multiple pressings of a same key can be expected, so that key is not used as an index entry.

When the number of index entries is not sufficient, a “next key” as described above, or the original partial address, may be typed to prompt marking the next set of relevant words. As noted above, the set of relevant words may be limited to words (or graphical objects) that appear in a dictionary. Such a dictionary may include individual examples as well as groups (e.g., “all icons” or “all bold words”). Optionally, the sets of words and/or indexing within words are selected in order of relevance, rather than in order of screen appearance.

In an exemplary embodiment of the invention, the intentions of a user may be guessed, or at least prioritized. In one example, an open menu, a modal dialog box or a single word on the screen will suggest that any entry probably refers to that object.

In an exemplary embodiment of the invention, indexing can also be used for selecting an icon. In an exemplary embodiment of the invention, a text string is associated with an icon, for example the text “start” is associated with the windows “start” icon. When indexing is generated, also that icon may be marked. Such associating may also be used for other addressing schemes.

In an exemplary embodiment of the invention, non-addressed items are also marked with an index, for example, window controls such as scroll bars or other items that a user is likely to want to access.

In an exemplary embodiment of the invention, the pointing mode may be a permanent mode, a temporary mode or a hybrid mode, for example one that allows both typing and pointing. In an exemplary embodiment of the invention, the following is a description of methods of carrying out typical user interface interactions, using a pointing mode.

Direct Pointing. Pressing a key button for 0.3-0.5 sec results in indication a beep. If the key is released, indexing tags appear (at words starting with the key letter). Otherwise, a normal repeat sequence of the key is initiated. Pressing one of indexing tags results in cursor movement to the location of the tag, after which the tags disappear. In a voice version (described in more detail below): saying “point at” or “jump”, followed by the first letter of a word or the whole word.

Relational Cursor Movement. One of two modes of cursor movement is selected by a toggle key (Alt or Ctrl):

a. Navigation between objects.

b. Movement in pixel or character steps.

When in one of these modes, pressing the toggle key simultaneously with arrow key results in cursor movement in the opposite mode. Voice version: saying “change mode”.

Left/Right click, Double-click. In a laptop keyboard can use the dedicated “mouse buttons”. In a regular keyboard can use any two (configurable) buttons. Voice version: saying “left click”, “right click”.

Scroll (mouse wheel), Auto Scroll (x-button). Right double click enters auto scroll mouse mode (an indicating cursor appears). Manual scroll (mouse wheel) is activated by pressing Alt and arrow key simultaneously. Voice version: saying, “auto scroll”.

Drag-and-Drop (including window move/resize, drag/drop of selected areas). When the cursor is on an object or on a selected area, prolonged press of the left mouse button results in displaying a “virtual keyboard” layout on the screen and beginning of “drag” operation. The user may then either press cursor keys, or press one of the tags, both resulting in dragging the object to the desired destination. Also, the user may choose direct pointing in order to reach the destination. When the user releases the left mouse button, he performs the “drop” part of the action, and tags disappear. Voice version: saying “drag” selects the object and displays the virtual keyboard, as described above. Saying “drop”, drops the object.

Area/object(s) selection can be performed similarly to the drag and drop operation.

In an exemplary embodiment of the invention, a word is defined as in standard word processors. Alternatively or additionally, a word may be defined as any sequence of characters, with font style changes and/or spaces indicating a change in the word. In an exemplary embodiment of the invention, a user can select whether the operation will reach a word start, end, center, select the word or be any other position relative to the word. Such selection may be, for example, by default definition, automatic, based on a system assumption or manually, by using a suitable key stroke(s).

In some exemplary embodiments of the invention, when there is a text cursor on the screen, in addition to the pointing cursor, the text cursor remains in place, while the pointing cursor is bounced to a new location by the keyboard. Alternatively, the two cursors are bounced together. Alternatively, the text cursor joins the pointing cursor upon a left-mouse click. Alternatively, the user may specify whether to bounce the text cursor or leave it in tact.

In some exemplary embodiments of the invention, a user may request an interactive mode of operation. Only three key assignments are made: toggle switch between the typing mode and the pointing clicking mode, for example, key 118 (Fn), a key to indicate “YES” by the user, for example, key 128 (Enter), and a key to indicate “NO” by the user, for example key 129 (Esc). In this exemplary embodiment, once the toggle key is in the pointing mode, the computer interacts with the user, by questions to which the user may reply with yes or no. For example, after the toggle switch is struck to indicate pointing mode, the computer will ask: “Point by area-designation?” The method of this embodiment may be slightly more time-consuming, but the user is spared the need to remember the special key assignments.

In some exemplary embodiments of the invention, toggle key 118 and/or other keys which define the functionality of the pointing mode, are replaced by a typed command (which can be captured by the mapping software), a keyboard chord, a voice command to a microphone connected to the computer, a mechanical switch added to the keyboard, or even an external switch or a foot paddle which may be connected to the computer (for example, via the mouse socket).

In some exemplary embodiments of the invention, when using the area-designation pointing mode, only a portion of the screen area is addressed. Alternatively or additionally, the resolution of addressing is different for different parts of the screen, for example responsive to their content, frequency of access and/or their distance from the current cursor position.

The mapping software may be provided for many graphical operating systems, for example MS WINDOWS, X11, Mac-OS, and OS/2. In an exemplary embodiment of the invention, a single interface is provided for many such systems, to allow a user to be. comfortable with many such systems.

The above-described mapping software can be integrated with a computer in various ways. In an exemplary embodiment of the invention, especially suitable for MS windows, the mapping software is implemented as a keyboard driver. Alternatively or additionally, the mapping software is implemented as a mouse driver. Possibly, the mouse can continue working in parallel with the mapping software, however, in some cases, a user may desire to disable the mouse. Possibly, the mapping software captures window draw functions, as is known in the art, so as to keep track of the display. Alternatively or additionally, the mapping software reads the required information directly from the frame-buffer. Alternatively, the mapping software may be integrated into the operating system, possibly as a patch. In laptop computers, for example, the mapping software may be implemented on a hardware level, so as to generate suitable mouse and keyboard signals to the motherboard.

In an exemplary embodiment of the invention, the mapping software comprises operating system dependent and operating system independent modules. In an exemplary embodiment of the invention, the operating system independent modules include modules for managing the interaction with the user, for matching addresses to content and for modifying and for retrieving screen content. Operating system dependent modules can include, for example, the specific interfaces to the keyboard (or other input device) and the screen, and a module for interacting with the operating system for determining what is being drawn on the screen.

In an exemplary embodiment of the invention, a user can designate, for example by keystroke or based on mouse focus, a window to which to limit the mapping and positioning. Alternatively or additionally, different maps and/or map resolutions may be provided for each window. In an exemplary embodiment of the invention, the mapping covers the entire window, including menus and/or window controls. Although the pointing function is preferably provided at the operating system level, so that it can be independent of application specifics, in some embodiments of the invention, the pointing may be provided at an application level, at least for some of the features described herein.

In an alternative embodiment, a smart keyboard is provided that receives an indication of the screen contents and locally processes keystrokes using this indication to determine a position for a cursor. In one example, the indication comprises a stream of text content of the frame buffer transmitted by RS232 from the computer (or other device, such as a TV) to the keyboard. The processing may be as described above.

The above invention has been described mainly with reference to standard PC keyboards, however, it may be applied to devices with no standard keyboards especially such devices with a limited or no graphical pointing ability or in which a mouse or other dedicated pointing device is inconvenient to use, for example, laptops, PDAs, devices with folding keyboards, Java machines, set-top boxes (e.g., using a remote control), digital TVs and cellular telephones. In such devices, other selections of keys and mapping of keys may be provided for.

In an exemplary embodiment of the invention, the keyboard is limited with respect to the number of available keys (or distinct recognizable sounds, in a speech entry system or a DTMF system). In an exemplary embodiment of the invention, a recursive grid-type mapping is used, as described above. Alternatively or additionally, each key can represent multiple characters, for example, “2” can be any one of {2, a, b, c}. In an exemplary embodiment of the invention, these other possibilities are not used for generating an index, to allow for multiple entry of the same key, to select a letter. Alternatively or additionally, each key entry is assumed to represent the entire set, so, for example, all words starting with one of {2, a, b, c} are selected for indexing or mapping, when the “2” key is pressed. This is a type of pattern matching which is indicated above as a possibility in address entry. It is expected that, in general, any original ambiguity between possibilities will be narrowed down to a small number as the user enters more characters.

In addition, the above methods of cursor motion control may be used as to fine tune cursor commands entered by other means, such a pointing devices, eye-gaze devices, touch screens and/or speech commands. Alternatively or additionally, these alternate input means may be used to fine-tune a cursor position entered as described herein.

Further, it is noted that alternatively to using a keyboard to enter text, other means, such as speech and pen entry means may be used. An additional benefit of pen entry is the ability to draw geometrical shapes that correspond to screen portions. Optionally, such input entry is used to navigate over the entire screen, rather than within a particular application. However, in an exemplary embodiment of the invention, once a particular window has been selected, a within-window or within application navigation scheme may be used, possibly even for hidden parts of the window.

With regard to speech entry, in some embodiments of the invention a lower quality speech entry system is used. In one example, all that is necessary is to recognize letters and digits, for example for use in direct or indirect addressing. Alternatively or additionally, speech may be used for mode switching. Alternatively or additionally, a voice mouse mode is used for relative motion of the cursor.

In an exemplary embodiment of the invention, when a speech pattern is received, a template matching method is used to recognize the speech content. However, matching is only to templates of words that are on the screen, so there is less matching actions to be performed and a greater latitude in the speech signal can be allowed. Possibly, only constants are matched.

In a combined mode, the index and/or a partial address are entered in one input modality, for example voice or keyboard, and the rest is entered in another modality, for example keyboard or speech.

In an exemplary embodiment of the invention, matching templates for the screen contents, or a list of templates to use, are provided prior to the entry by the user, for example, with the display page (e.g., an Internet), or them being calculated as the display is generated.

A particular application which can utilize speech control is a virtual reality application, in which the user's display comprises goggle that display a virtual world or an overlay. The “mapping” can optionally be provided using the display goggles. In a cellular telephone application, or in an application where a cable TV set top box (or other display device) is programmed via telephone connection, voice and DTMF can utilize the existing microphone.

In an exemplary embodiment of the invention, the above methods of text recognition on a computer screen are used to automatically alert a user or perform some other task responsive to text appearing on a display. In one example, such a software can be used as a censor to blacken a screen if sexually explicit language appears on the screen. In another example, a user that is inundated by the data flowing through the screen can be assured that when a desired key word appears, it position will be marked and he will be alerted.

The above description has focused on pointing using a cursor. However, in some embodiments of the invention, the system being interfaced with does not use a cursor. The above method scan, however, be applied to such a system, if the pointing method (e.g., direct addressing) is used to indicate a location to the system internal functions. Once the location is noted by the system, it maybe used to affect control of the system, for example by selecting an icon.

It should be appreciated that the above-described embodiments contain many features, not all of which need be practiced in all embodiments of the invention. Rather, various embodiments of the invention will utilize only some of the above described techniques, features or methods and/or combinations thereof. Further in addition, various modifications will be readily apparent to and may be readily accomplished by persons skilled in the art without departing from the spirit and the scope of the above teachings.

The present invention has been described in terms of exemplary, non-limiting embodiments thereof. It should be understood that features described with respect to one embodiment may be used with other embodiments and that not all embodiments of the invention have all of the features shown in a particular figure. Although some exemplary embodiments may have been described only as method, the scope of the invention includes software and/or hardware required to perform the methods, typically a personal computer. Additionally, the scope of the invention includes diskettes, CDs and/or other computer storage media including thereon representations of software suitable for carrying out at least one embodiment of the present invention. In particular, the scope of the invention is not defined by the exemplary embodiments but by the following claims. When used in the following claims, the terms “comprises”, “comprising”, “includes”, “including” or the like mean “including but not limited to”.

1. A method of indicating by a user of a screen location, on a system having a screen displaying content, comprising:
entering at least a partial screen address, defining an absolute position on said screen, wherein said screen address can indicate substantially any location on said screen;
determining a screen location corresponding to said at least a partial address; and
pointing, by the system, to the screen location indicated by the at least a partial screen address.

2. A method according to claim 1, wherein entering comprises typing on a keyboard.

3. A method according to claim 1, wherein entering comprises typing on a keypad lacking individual keys for letters.

4. A method according to claim 1, wherein entering comprises entry by voice.

5. A method according to claim 4, wherein said voice entry comprises annunciation of characters.

6. A method according to claim 1, wherein entering comprises entry by pen input.

7. A method according to claim 1, wherein determining comprises matching said at least a partial location to an address of said screen location.

8. A method according to claim 1, wherein determining comprises analyzing a content at said screen location to determine an address of said screen location.

9. A method according to claim 8, wherein said determining is performed prior to said entry.

10. A method according to claim 8, wherein said determining is performed after said entry.

11. A method according to claim 1, wherein each screen location has a fixed address, independent of content displayed on said screen.

12. A method according to claim 1, wherein each screen location has a temporary screen address, is related to a content displayed at said location.

13. A method according to claim 12, wherein said temporary address comprises a description of said content.

14. A method according to claim 12, wherein said address comprises a message embedded in said content.

15. A method according to claim 8, wherein analyzing comprises analyzing at least one image displayed on said screen, for matching a substance of said image to said at least partial screen address.

16. A method according to claim 8, wherein analyzing comprises analyzing text displayed on said screen, for matching said text to said at least a partial screen address.

17. A method according to claim 8, wherein analyzing comprises analyzing at least one graphical object displayed on said screen, for matching said at least one graphical object to said at least partial screen address.

18. A method according to claim 8, wherein analyzing comprises analyzing an indication associated with at least one graphical objects displayed on said screen, for matching said at least one graphical object to said at least partial screen address.

19. A method according to any of claims 1-18, wherein said at least partial screen address is independent of the existence of one or more applications whose execution is displayed on said screen.

20. A method according to any of claims 1-18, wherein said at least partial screen address is dependent on the existence of one or more applications whose execution is displayed on said screen.

21. A method according to any of claims 1-18, wherein determining comprises fine-tuning said location responsive to user input after a first location determination.

22. A method according to claim 21, wherein said fine-tuning comprises:
associating an index tag with each of a plurality of potential screen locations; and
receiving a user input indicating which of the indexed screen location to select.

23. A method according to claim 22, wherein said plurality of potential screen locations includes a content of graphical objects that the screen addresses relate to.

24. A method according to claim 21, wherein said fine tuning comprises receiving a relative motion indication from said user.

25. A method according to claim 21, wherein said fine tuning comprises receiving an absolute motion indication from said user.

26. A method according to claim 21, wherein said fine tuning comprises providing a higher resolution screen address mapping than used for said entry.

27. A method according to claim 21, wherein said fine tuning comprises receiving a user entry using an input modality other than used for said entry.

28. A method according to claim 27, wherein said entry input modality and said other input modality comprise speech input and keyboard entry.

29. A method according to claim 21, wherein said fine tuning comprises using a different addressing method than used for said determining prior to said fine tuning.

30. A method according to any of claims 1-18, wherein determining comprises fine tuning said location responsive to a content of said screen at said location.

31. A method according to claim 30, wherein said fine-tuning comprises determining at least one point of interest on said screen responsive to said at least partial address.

32. A method according to any of claims 1-18, wherein said at least partial screen address is a single character.

33. A method according to any of claims 1-18, wherein said at least partial screen address comprises at least two characters.

34. A method according to claim 11, wherein said at least partial screen address comprises
a first part corresponding to a first screen subdivision direction and a second part corresponding to a second screen subdivision direction.

35. A method according to any of claims 1-18, wherein said at least partial screen address comprises a complete screen address.

36. A method according to any of claims 1-18, wherein said at least partial screen address comprises only a part of a screen address.

37. A method according to any of claims 1-18, wherein said determining stops at a first found screen address that matches said at least partial address.

38. A method according to any of claims 1-18, wherein a complete screen address is unique for said screen.

39. A method according to any of claims 1-18, wherein said determining automatically selects from a plurality of matches to the at least partial address.

40. A method according to any of claims 1-18, comprising manually selecting from a plurality of matches to the at least partial address.

41. A method according to any of claims 1-18, comprising providing a dictionary containing an indication associating at least one of an addressing possibility and an addressing priority of screen objects.

42. A method according to claim 41, wherein said screen objects include text words.

43. A method according to claim 41, wherein said screen objects include icons.

44. A method according to claim 41, wherein said screen objects include graphic objects.

45. A method according to claim 41, wherein said dictionary defines a limited subset of screen objects as being addressable.

46. A method according to claim 41, wherein said dictionary is personalized for a user.

47. A method according to any of claims 1-18, comprising displaying an indication of a mapping of screen addresses to screen locations on said screen.

48. A method according to claim 47, wherein said indication comprises a grid.

49. A method according to claim 47, wherein said indication comprises a plurality of tags.

50. A method according to claim 47, wherein said indication comprises a keyboard image.

51. A method according to claim 47, wherein said indication is displayed using a gray-level shading.

52. A method according to claim 47, wherein said indication is displayed using a color shading.

53. A method according to claim 47, wherein said indication is displayed by modulating said screen content.

54. A method according to claim 53, wherein said modulating comprises inverting.

55. A method according to claim 53, wherein said modulating comprises embossing.

56. A method according to claim 47, wherein said displaying is momentary.

57. A method according to any of claims 1-18, wherein said system comprises one of a desktop computer, an embedded computer, a laptop computer, a handheld computer, a wearable computer, a vehicular computer, a cellular telephone, a personal digital assistant, a set-top box and a media display device.

58. A method according to any of claims 1-18, wherein said pointing comprises bouncing a text cursor.

59. A method according to any of claims 1-18, wherein said pointing comprises bouncing a selection cursor.

60. A method according to any of claims 1-18, comprising receiving an entry from said user corresponding to a desired mouse action.

61. A method according to any of claims 1-18, wherein said determining is limited to a part of the screen.

62. A method according to claim 61, wherein said part of a screen comprises a window.

63. A method according to any of claims 1-18, wherein said determining comprises determining on an entire screen.

64. A method according to any of claims 1-18, wherein said determining comprises determining in across windows of different applications on said screen.

65. A method according to any of claims 1-18, wherein said screen addresses indicate said locations at a high spatial resolution.

66. A method according to any of claims 1-18, wherein said screen addresses indicate said locations at a low spatial resolution.

67. A method according to any of claims 1-18, wherein said screen addresses indicate said locations at a varying spatial resolution.

68. A method of navigating on a screen displaying a plurality of display elements, relating to a plurality of different applications, comprising:
defining a subset of said display elements to be relevant, including subset display elements from at least two unrelated applications;
receiving a user input indicating a relative motion, said input indicating a count and a direction; and
responsive to said user input, automatically selecting a subset display element of said subset that is distanced the inputted count of subset elements in the inputted direction; and
pointing to said selected display element.

69. A method of navigating on a screen displaying a plurality of display elements, relating to a plurality of different applications, comprising:
defining a subset of said display elements to be relevant, including subset display elements from at least two unrelated applications;
receiving a user input an absolute position, which is adjacent to some of said plurality of display elements; and
responsive to said user input, automatically selecting at least one subset display element of said subset included in said some of said plurality; and
pointing to said selected display element.

70. A method according to claim 68 or claim 69, wherein defining comprises providing a dictionary of associations between display elements and addressability.

71. A method according to claim 70, wherein said dictionary is personalized for a user.

72. A method according to claim 68 or claim 69, wherein said user input is provided using a mouse.

73. A method according to claim 68, wherein said user input is provided using a cursor key.

74. A method according to claim 68 or claim 69, wherein said user input is provided using a speech input.

75. A method according to claim 68, comprising determining a granularity of said selecting responsive to screen content around said display element.
